(19) United States
(12) Patent Application Publication
(10) Pub. No.: US 2010/0287988 A1
(43) Pub. Date: Nov. 18, 2010

(54) COMPOSITE GEMSTONE AND METHOD OF MAKING SAME

(75) Inventor: Aakar C. SHAH, Mumbai (IN)

Correspondence Address: Kirschstein, Israel, Schiffmiller & Pieroni, P.C., 425 FIFTH AVENUE, 5TH FLOOR, NEW YORK, NY, 10016-2223, US

(73) Assignee: K. P. SANGHVI INTERNATIONAL LTD, New York, NY (US)

(21) Appl. No.: 12/467,684

(22) Filed: May 18, 2009

(51) Int. Cl. A44C 17/02; B23P 5/00

(52) U.S. Cl. 63/28; 29/10

(57) ABSTRACT

A composite gemstone, and a method of making the same, employ a generally conically-shaped setting having a head, a vertex spaced therefrom along an axis, and a conical wall surrounding the axis and extending between the head and the vertex. The head and the conical wall both have multiple sockets extending therein. The sockets on the conical wall are spaced angularly apart around the axis. Some of the sockets are spaced at different axial distances away from the vertex. The head and the conical wall both have multiple integral prongs that are spaced angularly apart around each socket. Multiple miniature stones are mounted in the sockets and held therein by the prongs surrounding the respective socket. The miniature stones are mounted in close adjacent relationship both on the head and on the conical wall to simulate that the composite gemstone is of a one-piece construction.

### BACKGROUND OF THE INVENTION

This invention generally relates to a composite gemstone and a method of making the same by mounting a plurality of smaller gemstones on a setting to simulate a larger single gemstone.

Semi-precious and precious gemstones, such as diamonds, set on jewelry, such as rings, are relatively expensive due, for example, to their size, rarity and appearance. Typically, the larger the gemstone, the more expensive the gemstone is. Hence, to reduce such expense, it is known to fit several smaller gemstones together, or to mount several diamond chips in a metal setting, to simulate a single larger gemstone. It is also known to cluster multiple diamond chips in a pavé or micropavé setting in which the metal setting does not show between the chips. All these multi-stone mounting techniques produce a jewelry setting that can be sold at a lower price as compared to a single larger stone setting.

### SUMMARY OF THE INVENTION

One aspect of this invention is directed to a composite gemstone comprising a setting having a head, a vertex spaced along an axis away from the head, and a tapered wall surrounding the axis and extending between the head and the vertex. Preferably, the setting is generally conically-shaped, and the tapered wall is a conical wall. The head and the conical wall both have a plurality of sockets extending into the head and the conical wall. The sockets on the conical wall are spaced angularly apart around the axis. Some of the sockets are spaced at different axial distances away from the vertex. The head and the conical wall both have a plurality of prongs integral with the head and the conical wall. The prongs are spaced angularly apart around each socket. A plurality of miniature stones is each mounted in a respective socket and held in the respective socket by the prongs surrounding the respective socket. The miniature stones are mounted in close adjacent relationship both on the head and on the conical wall to simulate that the composite gemstone is of a one-piece construction.

The setting is advantageously constituted of a metal material, such as silver or gold, and of two metal parts connected together, for example, by being fused. The head is advantageously convexly curved. The sockets on the head are preferably spaced angularly apart around the axis. Some of the miniature stones on the head are spaced at different axial distances away from the vertex. Each socket is preferably circular, and each miniature stone is also preferably circular. The prongs surrounding the respective socket have bent portions overlying a respective miniature stone in the respective socket. The miniature stones are preferably diamonds to simulate that the composite gemstone is a single diamond.

Another aspect of this invention is directed to the gemstone setting itself. The setting is preferably generally conically-shaped and includes a head, a vertex spaced along an axis away from the head, and a tapered, preferably conical, conical wall surrounding the axis and extending between the head and the vertex. The head and the conical wall both have a plurality of sockets extending into the head and the conical wall. The sockets on the conical wall are spaced angularly apart around the axis. Some of the sockets are spaced at different axial distances away from the vertex. The head and the conical wall both have a plurality of prongs integral with the head and the conical wall. The prongs are spaced angularly apart around each socket.

Still another aspect of this invention is directed to a method of making a composite gemstone, which is performed by shaping a material of a setting with a head, a vertex spaced along an axis away from the head, and a tapered wall surrounding the axis and extending between the head and the vertex; removing material from the head and the tapered wall to form a plurality of sockets extending into the head and the tapered wall, spacing the sockets on the tapered wall angularly apart around the axis, and spacing some of the sockets at different axial distances away from the vertex; removing additional material from the head and the tapered wall to form a plurality of prongs integral with the head and the tapered wall, and spacing the prongs angularly apart around each socket; and mounting a plurality of miniature stones each in a respective socket, holding each miniature stone in the respective socket by the prongs surrounding the respective socket, and mounting the miniature stones in close adjacent relationship both on the head and on the tapered wall to simulate that the composite gemstone is of a one-piece construction.

Thus, multiple small stones, both cut or uncut, or chips are mounted in a metal setting and simulate a single larger gemstone. This composite gemstone can be mounted in a ring, bracelet, necklace, earring, or like jewelry item. This composite gemstone can be sold at a lower price as compared to a single larger stone.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is an enlarged, exploded, perspective view of a two-part setting for use in making a composite gemstone in accordance with this invention;

FIG. 2 is a side elevational view of the setting of FIG. 1 after the two parts have been connected together;

FIG. 3 is a perspective view of the assembled setting of FIG. 2 after formation of a plurality of sockets;

FIG. 4 is a perspective view of the socketed setting of FIG. 3 after formation of a plurality of pavé prongs;

FIG. 5 is a perspective view of the pavé pronged setting of FIG. 4 after mounting of miniature stones in the sockets and after deformation of the prongs to hold the miniature stones in the sockets; and

FIG. 6 is an enlarged perspective view of the composite gemstone made in accordance with this invention.

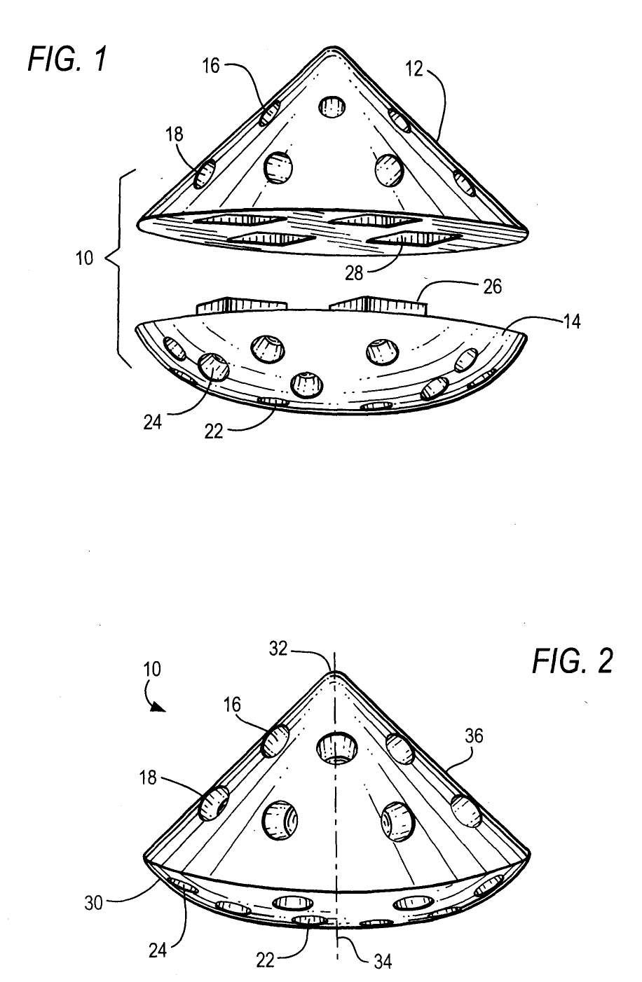

### DETAILED DESCRIPTION OF THE PREFERRED EMBODIMENTS

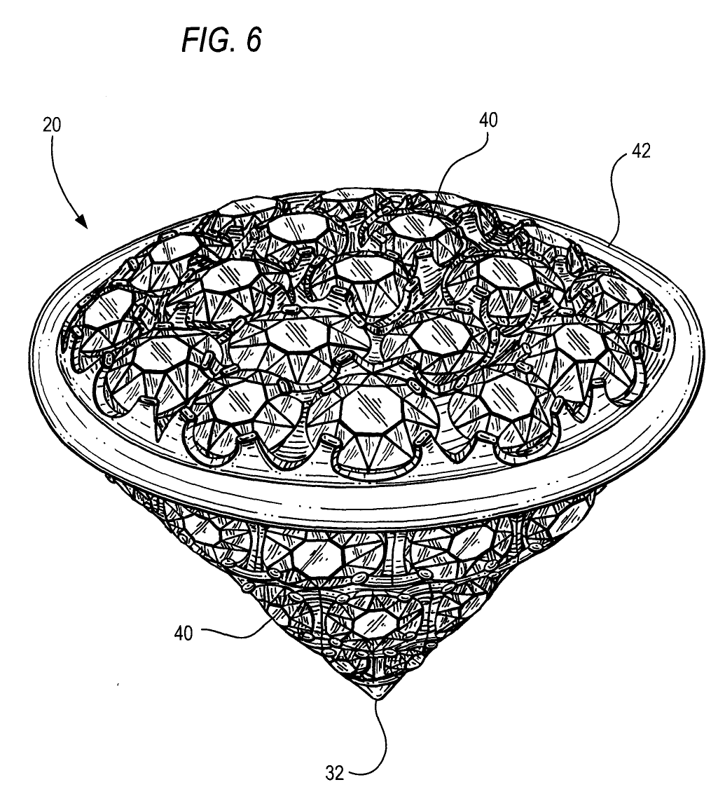

Referring now to the drawings, reference numeral 10 generally identifies a generally conically-shaped setting for use in making a composite gemstone 20, as best seen in FIG. 6. The setting 10 is advantageously formed of a conical part 12 and a head part 14. Each part 12, 14 is advantageously constituted of a metal material, such as silver or gold, and is cast with a plurality of sockets 16, 18, 22, 24, as described below. After casting, the two metal parts 12, 14 are connected together, for example, by being heat-fused. To assist the interconnection, the head part 14 has a plurality of projections 26 extending therefrom, which are fitted into a corresponding plurality of recesses 28 extending into the conical part 12.

Once interconnected, as best seen in FIG. 2, the conical setting 10 has a head 30, advantageously convexly curved, a vertex 32 spaced along an axis 34 away from the head 30, and a conical wall 36 surrounding the axis 34 and extending between the head 30 and the vertex 32. The head 30 and the conical wall 36 both have the plurality of sockets 16, 18, 22, 24, as described above, extending into the head 30 and the conical wall 36. The sockets 16, 18 on the conical wall 36 are spaced angularly, preferably equiangularly, apart in annular rows around the axis 34. The rows of sockets 16, 18 are spaced at different axial distances away from the vertex 32. As illustrated, the row of sockets 16 is spaced closer to the vertex 32 than the row of sockets 18. More or less than the two illustrated annular rows of the sockets 16, 18, and more or less than the illustrated number of the sockets 16, 18 in each annular row, are contemplated by this invention. In addition, the sockets need not be arranged in annular rows, but could also be randomly arranged on and along the conical wall 36 at various distances from the vertex 32.

The sockets 22, 24 on the head 30 are also spaced angularly, preferably equiangularly, apart in annular rows around the axis 34. The rows of sockets 22, 24 are spaced at different axial distances away from the vertex 32. As illustrated, the row of sockets 24 is spaced closer to the vertex 32 than the row of sockets 22. More or less than the two illustrated annular rows of the sockets 22, 24, and more or less than the illustrated number of the sockets 22, 24 in each annular row, are contemplated by this invention. In addition, the sockets need not be arranged in annular rows, but could also be randomly arranged on and along the head 30 at various distances from the vertex 32.

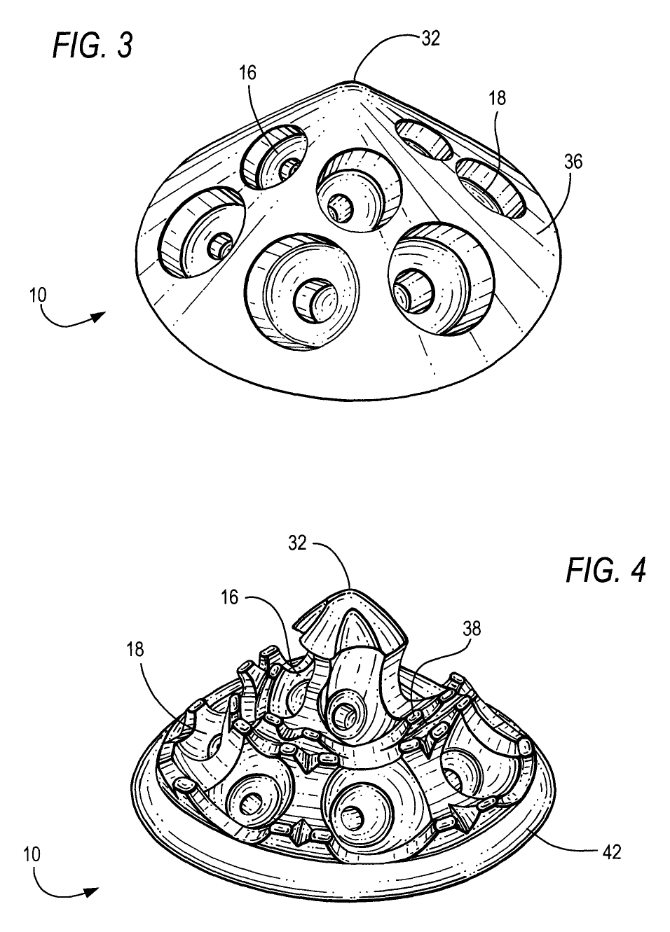

As best seen in FIG. 3, each of the sockets 16, 18, 22, 24 is enlarged by removing metal material therefrom, preferably by using a rotary drill, but can also be hand-cut. Advantageously, each enlarged socket is circular in cross-section. The size and shape of the enlarged socket is dependent on the size and shape of the miniature stones to be placed therein, as described below.

As best seen in FIG. 4, additional metal material is removed, preferably by drilling or by hand-cutting, from the setting 10 in the annular regions around each socket 16, 18, 22, 24 to form a plurality of projections or pavé prongs 38 integral with the head 30 and the conical wall 36. The pavé prongs 38 are spaced angularly, preferably equiangularly, apart around each socket 16, 18, 22, 24. Advantageously, a peripheral shoulder 42 is formed at the junction between the head 30 and the conical wall 36.

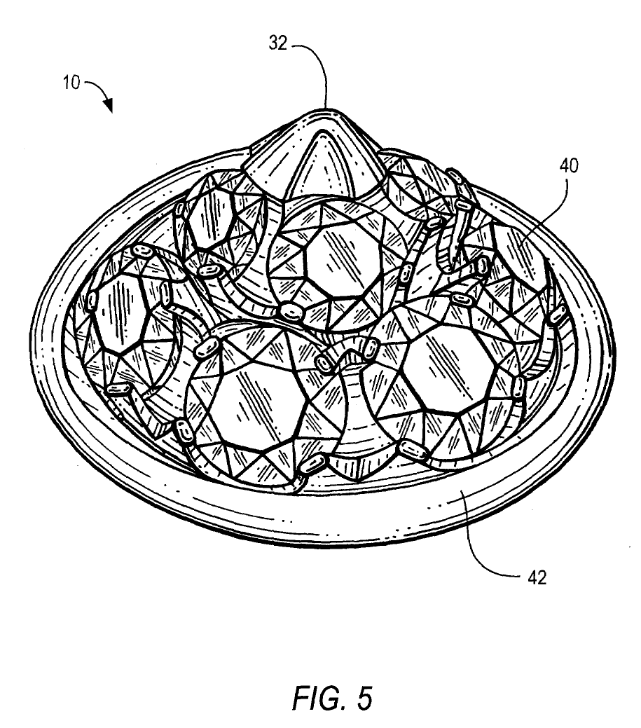

As best seen in FIG. 5, a plurality of miniature stones 40, each preferably being a full-cut single diamond, is each mounted in a respective socket 16, 18, 22, 24 and held in the respective socket by the prongs 38 surrounding the respective socket. To hold the stones in place, upper portions of the prongs 38 are bent, upset and deformed due to the malleable nature of the metal material of the setting 10, to lay over peripheral edge portions of each miniature stone 40. As best seen in FIG. 6, the miniature stones 40 are mounted in close adjacent relationship both on the head 30 and on the conical wall 36 to simulate that the composite gemstone is of a one-piece construction. Essentially, a substantial portion of the exterior surface of the setting 10 is covered with the stones 40. When the miniature stones are diamonds, the composite gemstone 20 of FIG. 6 resembles a single large diamond.

The method of making the composite gemstone 20 is performed by generally conically shaping the material of the setting with the head 30, the vertex 32 spaced along the axis 34 away from the head 30, and the conical wall 36 surrounding the axis 34 and extending between the head 30 and the vertex 32; removing the material from the head 30 and the conical wall 36 to form the plurality of sockets extending into the head 30 and the conical wall 36, spacing the sockets on the conical wall 36 angularly apart around the axis, and spacing some of the sockets at different axial distances away from the vertex 32; removing additional material from the head 30 and the conical wall 36 to form the plurality of prongs 38 integral with the head 30 and the conical wall 36, and spacing the prongs 38 angularly apart around each socket; and mounting the plurality of miniature stones 40 each in a respective socket, holding each miniature stone 40 in the respective socket by the prongs 38 surrounding the respective socket, and mounting the miniature stones 40 in close adjacent relationship both on the head 30 and on the conical wall 36 to simulate that the composite gemstone 20 is of a one-piece construction.

Thus, multiple small stones 40, either full-cut, or single-cut or uncut, or chips, preferably having a weight of about 0.004 to 0.02 carats, and also of larger weights, are mounted in the metal setting 10 and simulate a single larger gemstone 20. This composite gemstone 20 can be mounted in a ring, bracelet, necklace, earring, or like jewelry item. For example, a ring can be provided with a set of ring prongs for holding the composite gemstone 20 by deforming the ring prongs to overlie the shoulder 42.

It will be understood that each of the elements described above, or two or more together, also may find a useful application in other types of constructions differing from the types described above. For example, although the invention has been described and illustrated as a round gemstone, other styles and shapes, such as oval, square, pear, marquise and emerald, are also contemplated by this invention. Thus, the setting need not be conical as shown, but could have other shapes.

While the invention has been illustrated and described as embodied in a composite gemstone, and a method of making the same, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A composite gemstone, comprising:
a setting having a head, a vertex spaced along an axis away from the head, and a tapered wall surrounding the axis and extending between the head and the vertex, the head and the tapered wall both having a plurality of sockets extending into the head and the tapered wall, the sockets on the tapered wall being spaced angularly apart around the axis, some of the sockets being spaced at different axial distances away from the vertex, the head and the tapered wall both having a plurality of prongs integral with the head and the tapered wall, the prongs being spaced angularly apart around each socket; and
a plurality of miniature stones each mounted in a respective socket and held in the respective socket by the prongs surrounding the respective socket, the miniature stones being mounted in close adjacent relationship both on the head and on the tapered wall to simulate that the composite gemstone is of a one-piece construction.

2. The composite gemstone of claim 1, wherein the setting is generally conically-shaped and is constituted of a metal material.

3. The composite gemstone of claim 1, wherein the setting is comprised of two parts connected together.

4. The composite gemstone of claim 1, wherein the head is convexly curved.

5. The composite gemstone of claim 1, wherein the sockets on the head are spaced angularly apart around the axis, and wherein some of the miniature stones on the head are spaced at different axial distances away from the vertex.

6. The composite gemstone of claim 1, wherein each socket is circular, and wherein each miniature stone is circular.

7. The composite gemstone of claim 1, wherein the prongs surrounding the respective socket have bent portions overlying a respective miniature stone in the respective socket.

8. The composite gemstone of claim 1, wherein the miniature stones are diamonds to simulate that the composite gemstone is a single diamond.

9. A gemstone setting, comprising:
a head, a vertex spaced along an axis away from the head, and a tapered wall surrounding the axis and extending between the head and the vertex, the head and the tapered wall both having a plurality of sockets extending into the head and the tapered wall, the sockets on the tapered wall being spaced angularly apart around the axis, some of the sockets being spaced at different axial distances away from the vertex, the head and the tapered wall both having a plurality of prongs integral with the head and the tapered wall, the prongs being spaced angularly apart around each socket.

10. The setting of claim 9, wherein the setting is generally conically-shaped and is comprised of two metal parts connected together.

11. The setting of claim 9, wherein the head is convexly curved.

12. The setting of claim 9, wherein the sockets on the head are spaced angularly apart around the axis.

13. A method of making a composite gemstone, comprising the steps of:
shaping a material of a setting with a head, a vertex spaced along an axis away from the head, and a tapered wall surrounding the axis and extending between the head and the vertex;
removing material from the head and the tapered wall to form a plurality of sockets extending into the head and the tapered wall, spacing the sockets on the tapered wall angularly apart around the axis, and spacing some of the sockets at different axial distances away from the vertex;
removing additional material from the head and the tapered wall to form a plurality of prongs integral with the head and the tapered wall, and spacing the prongs angularly apart around each socket; and
mounting a plurality of miniature stones each in a respective socket, holding each miniature stone in the respective socket by the prongs surrounding the respective socket, and mounting the miniature stones in close adjacent relationship both on the head and on the tapered wall to simulate that the composite gemstone is of a one-piece construction.

14. The method of claim 13, wherein the shaping step is performed by conically shaping the setting, and a step of constituting the setting of a metal material.

15. The method of claim 13, wherein the shaping step is performed by forming the setting of two parts, and a step of connecting the two parts together.

16. The method of claim 13, wherein the shaping step is performed by convexly curving the head.

17. The method of claim 13, and a step of spacing the sockets on the head angularly apart around the axis, and a step of spacing some of the miniature stones on the head at different axial distances away from the vertex.

18. The method of claim 13, wherein the removing steps are performed by drilling into the setting material.

19. The method of claim 13, and a step of deforming portions of the prongs surrounding the respective socket to overlie a respective miniature stone in the respective socket.

20. The method of claim 13, and a step of selecting diamonds as the miniature stones to simulate that the composite gemstone is a single diamond.
